(19) United States
(12) Patent Application Publication
(10) Pub. No.: US 2012/0326457 A1
(43) Pub. Date: Dec. 27, 2012

(54) ACCESS-LIMITING BAR FOR DOORWAYS

(76) Inventor: DONALD MEAD, Hillsboro, OR (US)

(21) Appl. No.: 13/237,079

(22) Filed: Sep. 20, 2011

Related U.S. Application Data
(60) Provisional application No. 61/501,379, filed on Jun. 27, 2011.

(51) Int. Cl. E05C 19/00; B23P 11/00

(52) U.S. Cl. 292/259 R; 29/428

(57) ABSTRACT

A locking bar for use behind a closed door to prevent passage through the doorway. The locking bar includes a slot-and-pivot-pin combination to hold the bar securely in a vertical position when the locking function is not desired.

### REFERENCE TO RELATED APPLICATIONS

This application claims priority to U.S. Provisional Application No. 61/501,379, filed Jun. 27, 2011, which is incorporated herein by reference in its entirety.

### GOVERNMENT RIGHTS

Not applicable

### BACKGROUND OF THE INVENTION

The present invention generally relates to apparatus and methods for securing doors and, more specifically, to apparatus and methods for securing doors from the hinged side to prevent intrusion by unwanted or unexpected persons.

Standard doorknobs are typically fitted with locking mechanisms or doors may be outfitted with deadbolt locks that are contained in the door body and extend, when in a locked position, into the doorframe. These locks are intended to prevent persons outside the door from entering the room or area behind the door. Such locks generally operate on the same side of the door on which the hinges are present. Hinges are typically located on the “inside” of the space where the door is located.

Various methods using crossbars have been tried, with some using removable crossbars, which require storage when not in use, and others attached directly to the door hinges, which may be in the way when not in use.

As can be seen, there is a need for an improved apparatus and method that that prevents unwanted visitation, that is easy to install in an opening having a door, that is easy to operate, and that is unobtrusive and secure when not in use.

### SUMMARY OF THE INVENTION

In one aspect of the present invention, a system comprises a bar having a first end and a second end, the first end comprising an elongated slot; a first bracket, comprising fittings for attachment to a frame, a bracket slot adapted to receive the first end of the bar, and a pivot pin adapted to be received by the elongated slot in the first end of the bar; and a second bracket, comprising: fittings for attachment to a frame, and a holder configured to receive the second end of the bar; wherein the pivot pin in the first bracket extends into the elongated slot in the first end of the bar such that the bar is pivotably coupled to the first bracket; wherein the second end of the bar is received by the holder in the second bracket; and wherein the first end of the bar rests in the bracket slot when the bar is rotated to a vertical position having the elongated slot at the bottom.

In another aspect of the present invention, a system comprises a first bracket having a bracket slot and a pivot pin; a bar having a first end and a second end, the first end having an elongated slot; wherein the pivot pin is slidably engaged in the elongated slot; and a second bracket having a holder to receive the second end of the bar; wherein the bar rotates about the pivot pin to a vertical position and rests in the bracket slot.

In another aspect of the present invention, a method comprises the steps of milling an elongated slot at a first end of a bar having a first end and a second end; forming a bracket slot on a first bracket; inserting a pivot pin through the first bracket and through the elongated slot; wherein the bracket slot is adapted to receive the first end of the bar when the pivot pin is engaged in the elongated slot; and forming an angled rod on a second bracket; wherein the angled rod is adapted to receive the second end of the bar; and adapting the first bracket and the second bracket to be securely attached to a frame.

These and other features, aspects and advantages of the present invention will become better understood with reference to the following drawings, description and claims.

### BRIEF DESCRIPTION OF THE DRAWINGS

FIG. 1 is a perspective view of a locking bar according to an embodiment of the present invention, shown in use;

FIG. 2 is an exploded view of a support bracket from the embodiment shown in FIG. 1;

FIG. 3 is an exploded view of the pivot bracket from the embodiment shown in FIG. 1;

FIG. 4 is a front view of the locking bar embodiment shown in FIG. 1;

FIG. 5 is a section view taken along the line marked 5-5′ in FIG. 1, showing the position of the slot and the pivot pin in the pivot bracket when the locking bar is in use; and

FIG. 6 is a section view of the assembly in FIG. 5, this time showing the position of the slot and the pivot pin in the pivot bracket when the locking bar is not in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully

Broadly, embodiments of the present invention generally provide a locking bar assembly that may attached to a bracket on one side of a doorway, rotated to a position across the doorway, and held in place using a bracket on the other side of the doorway. The bar may be positioned across the middle section of the door on the opening side, meaning the side of the door that has the hinges. Unwanted ingress through the door from the other side is thereby prevented.

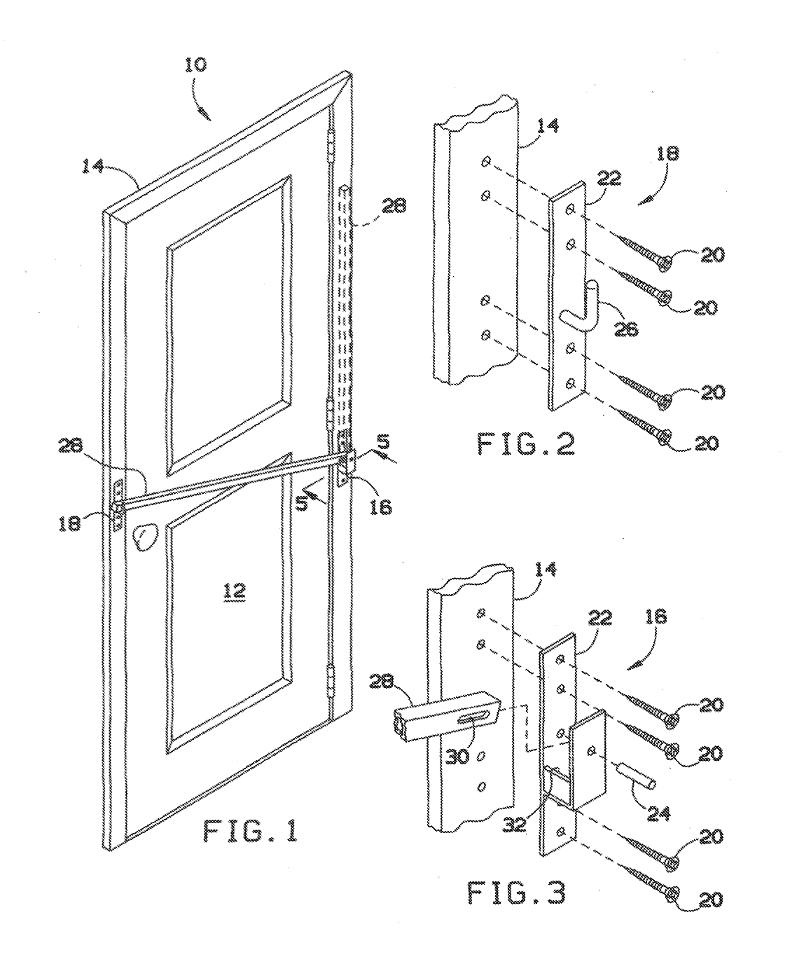

FIG. 1 illustrates an embodiment of the apparatus 10 of the present invention in use on a doorframe 14. The doorframe 14 may be made of wood, metal, or any other material to which the apparatus may be securely attached. A pivot bracket 16 and a support bracket 18, shown in FIGS. 2 and 3, may be attached to opposite sides of a doorframe 14. The support bracket 18 may be attached at a higher relative position than the pivot bracket 16.

The pivot bracket 16 may include a plate 22, typically made of steel, having an attached bracket slot 32 that is adapted to hold a pivot pin 24. The bracket slot 32 may be attached to the plate by welding or other appropriate methods. The pivot pin 24 may be engaged by the plate 22 at one end and the bracket slot 32 at the other end, and is typically welded into place. The support bracket 16 may include a plate 22, typically made of steel, having an attached holder 26. The holder 26 may take the shape of a hook or a U-shaped protrusion, and may generally have an angled portion to hold the rod end. For each bracket 16,18, the plate 22 may be secured to the doorframe 14 using screws 20 or other methods of secure attachment.

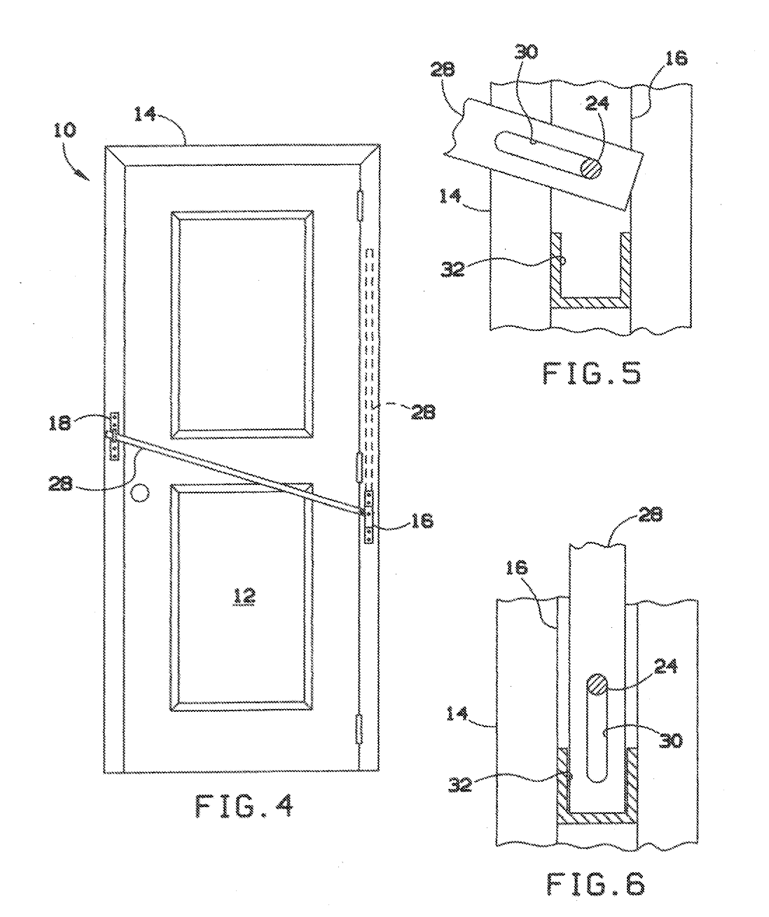

A bar 28, typically a steel rod or tube, that may have a slot 30 through one end. The bar 28 may be secured into the pivot bracket 16 by inserting the pivot pin 24 through the slot 30 and typically welding the pivot pin 24 into place, as shown in FIG. 3. The bar 28 may then pivot in the plane parallel to the door 12 about the pivot pin 24 through the slot 30 and oriented to rest in the holder 26 in the support bracket 18. This is the engaged position of the bar 28, which is shown in FIGS. 1 and 4. A spacer may also be added between the bar 28 and the door 12 to provide enhanced rigidity to the assembly, if desired.

If the locking function is not desired, the bar 28 may be pivoted to a vertical position, shown in shadow in FIGS. 1 and 4. FIG. 5 shows the pivot bracket 16 when the bar 28 is in a locked position. When the locked position is no longer desired, the end of the bar 28 may be lifted from the holder 26 in support bracket 18 and pivoted about the pivot pin 24 to a vertical position. The bar 28 may then slide into the bracket slot 32 using the slot 30, shown in FIG. 6. The combined effect of the slot 30, the pivot pin 24, and the bracket slot 32 is to retain the bar 28 in a vertical position, out of the way of the door 12 when the door 12 is in use. The bar 28 may be a telescoping or extendable bar to accommodate varying widths of door openings. These varying widths may be fixed positions. The bracket slot may be substantially U-shaped to aid in retention of the bar, but other shapes may be used within the scope of the invention.

As can be appreciated by those skilled in the art, embodiments of the present invention provide an improved apparatus and method of securing areas behind a door against unwanted access, and may substitute for or augment locks that may be present on the blocked door. Although steel is recited as a typical material for the apparatus of the present invention, other strong materials may be used without departing from the spirit and scope of the present invention.

It should be understood, of course, that the foregoing relates to exemplary embodiments of the invention and that modifications may be made without departing from the spirit and scope of the invention as set forth in the following claims.

We claim:

1. A system, comprising:
a bar having a first end and a second end, the first end comprising an elongated slot;
a first bracket, comprising:
fittings for attachment to a frame;
a bracket slot adapted to receive the first end of the bar; and
a pivot pin adapted to be received by the elongated slot in the first end of the bar; and
a second bracket, comprising:
fittings for attachment to a frame; and
a holder configured to receive the second end of the bar;
wherein the pivot pin in the first bracket extends into the elongated slot in the first end of the bar such that the bar is pivotably coupled to the first bracket;
wherein the second end of the bar is received by the holder in the second bracket; and
wherein the first end of the bar rests in the bracket slot when the bar is rotated to a vertical position having the elongated slot at the bottom.

2. The system of claim 1, wherein the bar is solid.

3. The system of claim 1, wherein the bar is hollow.

4. The system of claim 1, wherein the bar, the first bracket, and the second bracket are formed from steel.

5. The system of claim 1, wherein the bracket slot is substantially U-shaped.

6. The system of claim 1, wherein the holder in the second bracket is an angled section of steel rod.

7. The system of claim 1, wherein the fittings in the first bracket and the fittings in the second bracket are adapted to be secured to a wood frame.

8. The system of claim 1, wherein the fittings in the first bracket and the fittings in the second bracket are adapted to be secured to'a metal frame.

9. The system of claim 1:
wherein the fittings in the first bracket comprise:
an elongated plate having a plurality of passages therethrough; and
a plurality of screws that engage a frame through the plurality of passages.

10. The system of claim 1:
wherein the fittings in the second bracket comprise:
an elongated plate having a plurality of passages therethrough; and
a plurality of screws that engage a frame through the plurality of passages.

11. A system, comprising:
a first bracket having a bracket slot and a pivot pin;
a bar having a first end and a second end, the first end having an elongated slot;
wherein the pivot pin is slidably engaged in the elongated slot; and
a second bracket having a holder to receive the second end of the bar;
wherein the bar rotates about the pivot pin to a vertical position and rests in the bracket slot.

12. The system of claim 11, wherein the first bracket and the second bracket are adapted to be secured to a wood frame.

13. The system of claim 11, wherein the first bracket and the second bracket are adapted to be secured to a metal frame.

14. The system of claim 11, wherein the pivot pin engages the elongated slot at the point farthest from the bracket slot when the first end of the bar is resting in the bracket slot.

15. The system of claim 11, wherein the bar, the first bracket, and the second bracket are formed from steel.

16. A method, comprising the steps of:
milling an elongated slot at a first end of a bar having a first end and a second end;
forming a bracket slot on a first bracket;
inserting a pivot pin through the first bracket and through the elongated slot;
wherein the bracket slot is adapted to receive the first end of the bar when the pivot pin is engaged in the elongated slot; and
forming an angled rod on a second bracket;
wherein the angled rod is adapted to receive the second end of the bar; and
adapting the first bracket and the second bracket to be securely attached to a frame.

17. The method of claim 16, further comprising the step of:
welding the bracket slot to the first bracket.

18. The method of claim 16, further comprising the step of:
welding the pivot pin to the first bracket.

19. The method of claim 16, further comprising the step of:
welding the angled rod to the second bracket.
